(19) United States
(12) Patent Application Publication
(10) Pub. No.: US 2008/0089668 A1
(43) Pub. Date: Apr. 17, 2008

(54) Recording Apparatus

(76) Inventor: Yoshiharu Morita, Osaka (JP)

Correspondence Address: MCDERMOTT WILL & EMERY LLP, 600 13TH STREET, NW, WASHINGTON, DC, 20005-3096, US

(21) Appl. No.: 11/794,952

(22) PCT Filed: Dec. 5, 2005
(86) PCT No.: PCT/JP05/22270

§ 371 Date: Jul. 10, 2007

(30) Foreign Application Priority Data
Jan. 11, 2005 (JP) 2005-004377

(51) Int. Cl. H04N 5/91

(52) U.S. Cl. 386/96; 386/E05.003

(57) ABSTRACT

A video/audio recording apparatus comprises an audio encoding section 101 and a video encoding section 102 for encoding an audio signal or a video signal which is video/audio broadcast and input, and a code multiplexing section 103 for multiplexing the encoded audio signal and video signal. Based on an audio signal before encoding, the audio encoding section 101 detects the presence of a silent portion or extracts a feature amount, such as an amplitude level, a frequency spectrum or the like, of the audio signal. The result of the extraction is buried in a fixed value area of a header of a packet generated by encoding. Therefore, a correspondence relationship between a feature amount or the like extracted from a video/audio signal and the video/audio signal can be easily established without information or a process for the correspondence.

### RELATED APPLICATIONS

This application is the U.S. National Phase under 35 U.S.C. § 371 of International Application No. PCT/JP2005/022270, filed on Dec. 5, 2005, which in turn claims the benefit of Japanese Application No. 2005-004377, filed on Jan. 11, 2005, the disclosures of which Applications are incorporated by reference herein.

### TECHNICAL FIELD

The present invention relates to a video/audio recording apparatus, such as a hard disk recorder, a DVD recorder or the like, which encodes and saves a video signal or an audio signal onto a magnetic disk, an optical disc or the like. More particularly, the present invention relates to an apparatus having a function of extracting a feature amount of audio, which is used for determination of a commercial, digest playback, or the like.

### BACKGROUND ART

Among conventional video/audio recording apparatuses, for example, there is one which employs a technique of detecting a silent state or the like so as to perform an automatic commercial detection with respect to a broadcast video/audio signal or the like (see, for example, Patent Document 1).

Also, in recent years, recording apparatuses which convert an video/audio signal into a digital signal and record the digital signal into a storage apparatus are becoming widespread. In these recording apparatuses, a larger amount of video/audio broadcast or like has been able to be recorded since the capacity of the storage apparatus has been increased. Even so, since it is not efficient to record a non-compressed video/audio signal, a video/audio signal is typically encoded using a compression means, such as MPEG (Motion Picture Expert Group) 2 or the like, before being recorded. During playback, the signal is decompressed and reproduced.

In this kind of apparatuses, a large amount of video/audio broadcast has been able to be recorded, it is desired to be able to view only required scenes to a further extent. Specifically, the necessity of automatic commercial detection or removal or the like has further increased, and a highlight detecting function or the like has become more important. To achieve these functions, the contents of a video/audio signal need to be analyzed.

As described above, as an apparatus for encoding and recording a video/audio signal and performing commercial detection or the like, an apparatus is known which has a commercial detecting section or the like separately from an encoding process section, and detects a commercial based on an audio signal which is encoded and held in a memory (see, for example, Patent Document 2).
Patent Document 1: Japanese Unexamined Patent Application Publication No. 8-317342
Patent Document 2: Japanese Unexamined Patent Application Publication No. 2002-247516

### DISCLOSURE OF THE INVENTION

### Problems to be Solved by the Invention

However, when commercial detection or the like is performed using a commercial detecting section provided separately from an encoding process section as described above, it is difficult to establish a correspondence relationship between the detection result and a portion of a video/audio signal, which is required for a process, such as automatic commercial removal or the like. Specifically, it is difficult to establish synchronization or correspondence between a video/audio signal encoded by an encoding process section and an extracted feature amount or the like (to what tine of the video/audio signal the extracted feature amount or the like corresponds). Therefore, in order to store information indicating the correspondence relationship, or perform a correspondence process using the information, a circuit, microcodes or the like become complicated, leading to an increase in circuit scale, for example.

In view of the above-described points, an object of the present invention is to easily establish a correspondence relationship between a feature amount or the like extracted from a video signal or an audio signal and a video/audio signal or the like, and reduce or eliminate information or a process for the correspondence, thereby making it possible to easily reduce the circuit scale, for example.

### SOLUTION TO THE PROBLEMS

To achieve the object, a first apparatus according to an embodiment of the present invention comprises:
an encoding means for encoding at least one of a video signal and an audio signal to generate an encoded signal having a header;
a recording means for recording the encoded signal onto a recording medium;
a feature extracting means for extracting a predetermined feature state or a feature amount in the video signal or the audio signal; and
an extraction result setting means for, when the same fixed value is set or is to be set in headers of at least two encoded signals of a series of encoded signals, replacing the fixed value with an extraction result of the feature extracting means or setting the extraction result of the feature extracting means instead of the fixed value, in at least one of fixed value areas of the encoded signals in which the fixed value is set or is to be set.

Also, a second apparatus according to an embodiment of the present invention is the first apparatus, wherein the feature extracting means is configured to extract at least one of a silent state, an amplitude, and a frequency spectrum of the audio signal.

Also, a third apparatus according to an embodiment of the present invention is the first apparatus, wherein the feature extracting means is configured to extract at least one of an amplitude and a frequency spectrum of the video signal.

Thereby, a feature amount or the like extracted from a video signal or an audio signal is set in the fixed value area of a header, and is put in correspondence with a video/audio signal or the like. Also, even when data previously set in the fixed value area is overwritten with the feature amount or the like, since the previous data is a value common to a plurality of headers, the previous data can be easily restored.

Also, a fourth apparatus according to an embodiment of the present invention is the first apparatus, wherein the feature extracting means is configured to perform the extraction using a result of operation for encoding a video signal or an audio signal.

Thereby, it is possible to easily provide a circuit or program codes common to the feature extracting means and the encoding means.

Also, a fifth apparatus according to an embodiment of the present invention is the first apparatus, wherein the encoding is performed after extraction by the feature extracting means.

Also, a sixth apparatus according to an embodiment of the present invention is the fifth apparatus which further comprises
a buffer storage section,
wherein the encoding means and the feature extracting means perform the encoding or the extraction based on a content held by the buffer, and
the encoding means is configured to cause the buffer to hold a generated encoded signal.

Thereby, even when the content held by the buffer before encoding is overwritten by encoding, extraction is appropriately performed by the feature extracting means.

Also, a seventh apparatus according to an embodiment of the present invention is the first apparatus which further comprises
a fixed value restoring means for restoring an encoded signal in which an extraction result is set in the fixed value area of the header, to an encoded signal in which an original fixed value is set.

Also, an eighth apparatus according to an embodiment of the present invention is the seventh apparatus, wherein the recording means is configured to record the encoded signal restored by the fixed value restoring means onto the recording medium.

Thereby, it is possible to easily achieve, for example, compatibility with an apparatus which does not perform feature extraction.

Also, a ninth apparatus according to an embodiment of the present invention is the seventh apparatus, wherein the recording means records onto the recording medium an encoded signal in which an extraction result is set in the fixed value area of the header, while the fixed value restoring means performs the restoring with respect to an encoded signal reproduced from the recording medium.

Thereby, it is possible to easily achieve, for example, compatibility with an apparatus which does not perform feature extraction, and easily reduce storage capacity required for the recording medium, for example.

### EFFECT OF THE INVENTION

According to the present invention, it is possible to easily establish a correspondence relationship between a feature amount extracted from a video/audio signal or the like and a video/audio signal. In addition, information or a process for the correspondence can be reduced or eliminated, thereby easily reduce the circuit scale, for example.

### BRIEF DESCRIPTION OF THE DRAWINGS

FIG. 1 is a block diagram showing a major portion of a video/audio recording apparatus according to an embodiment of the present invention.

FIG. 2 is a block diagram showing a specific configuration of an audio encoding section 101 of FIG. 1.

FIG. 3 is a flowchart showing an exemplary operation of the audio encoding section 101 of FIG. 1.

FIG. 4 is a diagram for describing contents to be stored onto a hard disk.

### DESCRIPTION OF THE REFERENCE CHARACTERS

101 audio encoding section

101a working memory

101b feature extracting section

101c encoding process section

102 video encoding section

103 coding multiplexing section

### BEST MODE FOR CARRYING OUT THE INVENTION

Hereinafter, embodiments of the present invention will be described in detail with reference to the accompanying drawings.

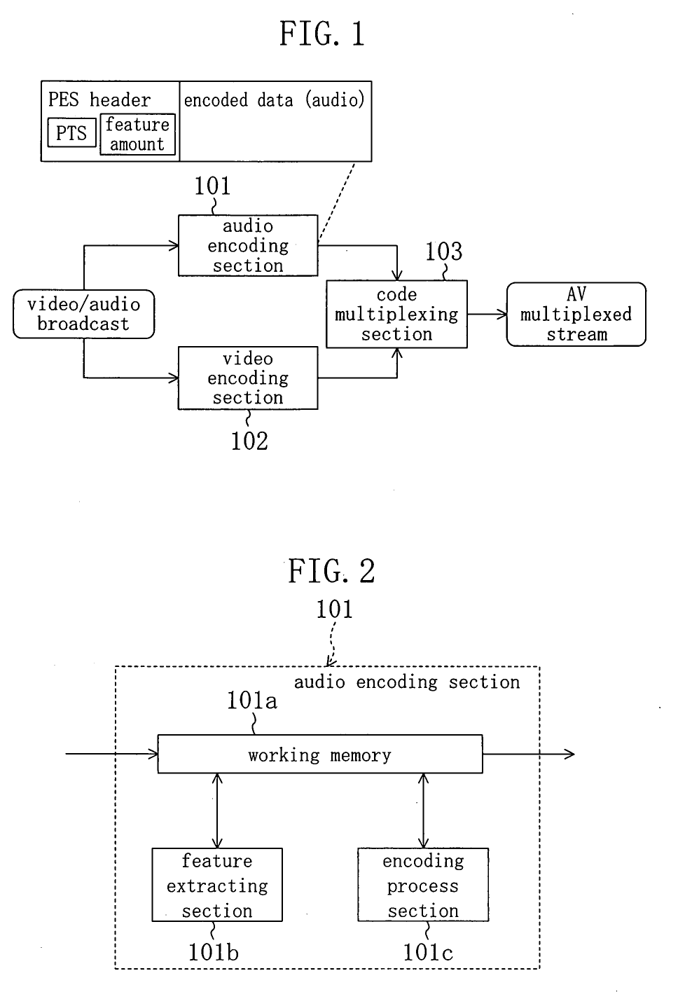

As shown in FIG. 1, a video/audio recording apparatus according to an embodiment of the present invention comprises an audio encoding section 101 and a video encoding section 102 for encoding an audio signal or a video signal which is, for example, video/audio broadcast and input, and a code multiplexing section 103 for multiplexing the encoded audio and video signals. Such a video/audio recording apparatus is used in, but is not limited to, for example, a hard disk recorder which encodes and saves an image signal onto a hard disk, an electrical apparatus with a built-in hard disk recorder, a television apparatus with a built-in hard disk recorder, a video recorder with a built-in hard disk recorder, a DVD player with a built-in hard disk recorder, and the like. The video/audio recording apparatus is formed as, for example, a part of a semiconductor integrated circuit for these apparatuses.

As shown in FIG. 2, the audio encoding section 101 comprises, for example, a working memory 101a, a feature extracting section 101b, and an encoding process section 101c.

The working memory 101a holds an audio signal before or after encoding. Note that, since the working memory 101a is used both before and after encoding, it is possible to suppress the number of circuits or input signal lines to a low level, so that the circuit scale is easily reduced, though the present invention is not limited to this.

The feature extracting section 101b detects that audio is silent or extracts a feature amount (e.g., an amplitude level or a frequency spectrum of an audio signal, etc.) based on, for example, an audio signal before encoding held in the working memory 101a. The result of the extraction is buried in a fixed value area of a header of a packet generated by encoding, as described in detail below.

Also, the encoding process section 101c performs an encoding process using a technique, such as MPEG2 or the like, to generate a packet including a header. Specifically, for example, a PES (Packetized Elementary Stream) packet including a PES header is generated.

Specifically, for example, when the encoding process section 101c is configured to perform an audio encoding process by a software process using microcodes or the like, the feature extracting section 101b can be implemented by providing software codes without particularly providing a circuit for feature extraction. Note that the present invention is not limited to this and, for example, when a silence detecting process or a feature amount extracting process cannot be implemented only by a software process, the whole or a part of the silence detecting process or the like may be implemented by hardware.

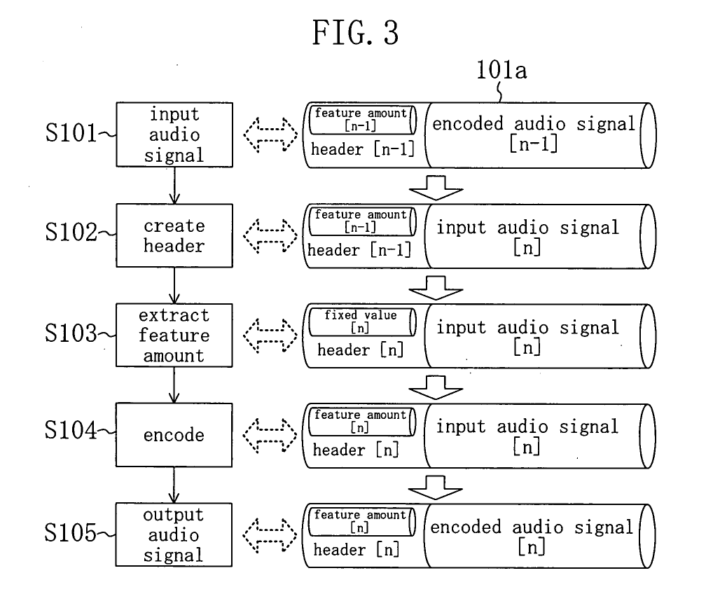

The thus-configured video/audio recording apparatus extracts a silent portion or a feature amount as shown in FIG. 3. Here, although the amount of data before encoding is typically larger than the amount of data after encoding, both the amounts are illustrated as being the same in FIG. 3 for the sake of simplicity.

(S101) Assuming that an encoding process has been performed with respect to, for example, an (n-1)-th audio signal and the encoded audio signal [n-1] is held in the working memory 101a, the audio encoding section 101, when receiving the next input audio signal [n] having a predetermined amount, overwrites the encoded audio signal [n-1] with the input audio signal [n].

(S102) For example, the encoding process section 101c generates a header [n] including a fixed value [n] along with, for example, time information, such as a PTS (Presentation Time Stamp), a DTS (Decoding Time Stamp) or the like, based on the input audio signal [n] held in the working memory 101a. The fixed value [n] is, for example, a value which is set in a series of (at least a plurality of) packets and does not vary from packet to packet. The generated header [n] is held in the working memory 101a (the header [n-1] is overwritten with the header [n]).

(S103) The feature extracting section 101b detects whether or not the audio is silent, or extracts an amplitude, a frequency spectrum or the like, based on the input audio signal [n] held in the working memory 101a. Here, for example, when silence detection is performed by software, an audio signal held in the working memory 101a is read into a digital signal processing circuit or the like by execution of the software. Alternatively, when silence detection or the like is performed by hardware, a signal output from the working memory 101a is input to a silence detection circuit or the like.

Information indicating whether or not audio is silent or various feature amounts, as the results of detection of silence and the like is buried as a feature amount [n] in the header [n], replacing the fixed value [n]. Specifically, when encoding is performed, a header is added so as to indicate the contents of encoded data, time information of encoded data or the like. If a fixed value portion which is not changed unless a parameter for encoding or other parameters are changed (in an encoded state) is present in such a header portion, an extracted feature amount can be saved or transferred to a portion which performs a process based on the feature amount by burying the extracted feature amount into such a fixed value portion, so that a register area, an external memory area or the like does not need to be newly secured. Note that a flag for indicating multiplexing in the fixed value portion may be provided as required. Also, for example, in a DVD recorder, if a fixed value is provided in all packets, the fixed value is known information in subsequent processing sections in the DVD recorder, and therefore, does not need to be transferred. (When compatibility with a DVD player or recorder having another standard or specification is required, (e.g., when a packet is output outside a DVD recorder or the like, i.e., when data is written onto an interchangeable recording medium, such as a DVD or the like), a predetermined fixed value may be restored.) On the other hand, when a fixed value is present in a certain encoded state, although the fixed value needs to be transferred, multiplexing is performed only in the first one packet in this case, i.e., not all packet headers need to be used for transfer. Therefore, as described above, an extracted feature amount is easily multiplexed in the fixed value portion. Note that an unused area portion, such as a header or the like, may be buried.

(S104) The encoding process section 101c encodes the input audio signal [n] held by the working memory 101a. The input audio signal [n] before encoding is overwritten with the encoded audio signal [n] generated by encoding.

(S105) The header [n] and the encoded audio signal [n] which are generated as described above and are then held in the working memory 101a are output as a packet from the audio encoding section 101. Hereinafter, a similar process is repeatedly performed with respect to input audio signals nail or later.

The encoded audio signal output from the audio encoding section 101 is multiplexed by the code multiplexing section 103 with packets of video signal output from the video encoding section 102, and the resultant signal is output as audio video (AV) multiplexed stream data and is then recorded onto a recording medium, for example. During the multiplexing, synchronization of an audio signal with a video signal is performed using time information, such as a PTS, a DTS or the like, which is buried in the PES header.

As described above, a packet in which information indicating a feature amount is buried in the fixed value portion or the unused area portion of the header, is subjected to a process, such as automatic commercial detection or removal, highlight detection for allowing digest playback, or the like, which is performed based on a feature amount extracted from the packet, by the code multiplexing section 103 or a subsequent processing section (not shown). In this case, since information indicating a feature amount is buried in the header of each packet as described above, a process which puts each packet in correspondence with a feature amount is easily performed. Specifically, when a feature amount is saved separately from a packet, information or a process for putting the feature amount in correspondence with an audio signal or the like is required. In contrast, such correspondence is guaranteed only by performing a process for each packet. In addition, as described regarding the operation of the code multiplexing section 103, synchronization of an audio signal with a video signal is easily achieved using time information or the like, and therefore, consequently, synchronization of a feature amount extracted from, for example, an audio signal with a video signal can be easily achieved.

Also, for example, when a process based on the result of a process, such as the automatic commercial detection or the like, is performed by a subsequent processing section, the result of the process may be buried in the fixed value portion or the unused area portion of a header.

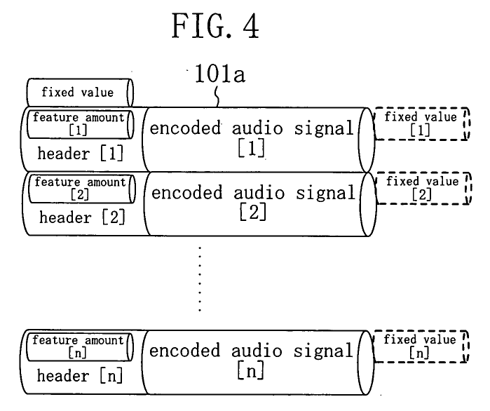

Also, when a feature amount is buried in the fixed value portion of a header, but not in the unused area portion, feature amount is overwritten with an original value of the fixed value portion to restore an original packet as required after a process, such as silence detection or the like, is performed. Here, in order to restore the fixed value portion in which a feature amount is buried to an original fixed value, the original fixed value needs to be saved when the feature amount is buried. For example, if a fixed value [1] to a fixed value [n] indicated by dashed lines are equal to each other as shown in FIG. 4, and the value is saved using a storage area having a small capacity for saving a single fixed value, a storage capacity for saving n-1 fixed values can be eliminated.

Note that, when a process common to a feature extracting process and a encoding process as described above is included, these processes may be performed by a common processing circuit or program. Specifically, for example, in the encoding process section 101c, silence detection or extraction of a feature amount, such as an amplitude level, a frequency spectrum or the like, may be performed so as to perform an audio encoding process. These pieces of information may be originally used for encoding or may be used for silence detection or as a feature amount for commercial detection or the like. When such a feature amount for encoding is used as a feature amount for commercial detection or the like, software codes or a circuit for extraction of a feature amount is not required, thereby making it possible to easily reduce the circuit scale or the like.

Here, when a feature amount obtained for encoding is successively updated before being referenced for a process, such as silence detection or the like, the feature amount may be saved and maintained in another memory area until being buried. The capacity of such a memory area may be smaller than the capacity of a memory in which non-compressed video/audio information is saved.

Also, the above-described apparatus may be applied to, for example, an apparatus which receives and records a digital broadcast. Specifically, since digital broadcasts are distributed as video/audio broadcasts in which video and audio have already been encoded, the digital broadcast does not necessarily need to be processed by an encoding process section during recording, as is different from a recording apparatus which digitally records an analog broadcast. However, for example, when an encoded video/audio broadcast is decoded and is then encoded again, the broadcast is processed by an encoding process section. Therefore, in this case, a function of extracting a feature amount is added to the encoding process section so that the encoding process section can be caused to perform silence detection with respect to a digital broadcast.

Also, in the above-described example, feature extraction is performed with respect to an audio signal. Alternatively, instead of or in addition to the feature extracting section 101b provided in the audio encoding section 101, a feature extracting section may be provided in the video encoding section 102 so as to perform similar feature extraction with respect to a video signal. Note that, even when a feature extracting section is provided both in the audio encoding section 101 and the video encoding section 102, both the feature extracting sections may be separately operated, or alternatively, both or only either of them may be allowed to operate.

Also, a packet as the fixed value portion thereof is overwritten with a feature amount may be recorded onto a recording medium, such as a hard disk or the like, and restored during playback or the like. Thereby, efficient recording or the like can be achieved. Specifically, when a required feature amount needs to be saved in each packet or the like, an additional storage capacity is required to save the feature amount into an area separate from an area for storing an encoded audio signal or to hold information about to what packet the feature amount corresponds along with the feature amount. In contrast, for example, by burying a feature amount in the fixed value portion of a header to record the feature amount onto a recording medium, such an increase in storage capacity can be avoided, for example.

### INDUSTRIAL APPLICABILITY

In the recording apparatus of the present invention, a correspondence relationship between a feature amount or the like extracted from a video signal or an audio signal and a video/audio signal or the like can be easily established. In addition, information or a process for the correspondence can be reduced or eliminated, thereby making it possible to easily reduce the circuit scale. The recording apparatus of the present invention is useful as, for example, a recording apparatus, such as a hard disk recorder, a DVD recorder or the like, which encodes and saves a video/audio signal onto a magnetic disk, an optical disc or the like.

1. A recording apparatus comprising:
an encoding means for encoding at least one of a video signal and an audio signal to generate an encoded signal having a header;
a recording means for recording the encoded signal onto a recording medium;
a feature extracting means for extracting a predetermined feature state or a feature amount in the video signal or the audio signal; and
an extraction result setting means for, when the same fixed value is set or is to be set in headers of at least two encoded signals of a series of encoded signals, replacing the fixed value with an extraction result of the feature extracting means or setting the extraction result of the feature extracting means instead of the fixed value in at least one of fixed value areas of the encoded signals in which the fixed value is set or is to be set.

2. The recording apparatus of claim 1, wherein the feature extracting means is configured to extract at least one of a silent state, an amplitude, and a frequency spectrum of the audio signal.

3. The recording apparatus of claim 1, wherein the feature extracting means is configured to extract at least one of an amplitude and a frequency spectrum of the video signal.

4. The recording apparatus of claim 1, wherein the feature extracting means is configured to perform the extraction using a result of operation for encoding a video signal or an audio signal.

5. The recording apparatus of claim 1, wherein the encoding is performed after extraction by the feature extracting means.

6. The recording apparatus of clam 5, further comprising:
a buffer storage section,
wherein the encoding means and the feature extracting means perform the encoding or the extraction based on a content held by the buffer, and
the encoding means is configured to cause the buffer to hold a generated encoded signal.

7. The recording apparatus of claim 1, further comprising:
a fixed value restoring means for restoring an encoded signal in which an extraction result is set in the fixed value area of the header, to an encoded signal in which an original fixed value is set.

8. The recording apparatus of claim 7, wherein the recording means is configured to record the encoded signal restored by the fixed value restoring means onto the recording medium.

9. The recording apparatus of claim 7, wherein the recording means records onto the recording medium an encoded signal in which an extraction result is set in the fixed value area of the header, while the fixed value restoring means performs the restoring with respect to an encoded signal reproduced from the recording medium.
